(19) United States
(12) Patent Application Publication
(10) Pub. No.: US 2006/0104259 A1
(43) Pub. Date: May 18, 2006

(54) System and method for executing a multi-modal transfer in a session initiation protocol (SIP) environment

(75) Inventors: Denise G. Caballero-McCann, Raleigh, NC (US); Stephen Levy, Cary, NC (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 10/989,017

(22) Filed: Nov. 15, 2004

(51) Int. Cl. H04L 12/66

(52) U.S. Cl. 370/352

(57) ABSTRACT

A method for communicating data in a session initiation protocol (SIP) environment is provided that includes initiating a SIP communication session that involves a first endpoint and a second endpoint. The method also includes identifying a portion of data that resides in a network and communicating the data to the second endpoint. In more particular embodiments, the method may further include identifying a uniform resource locator that includes the data and directing the second endpoint to the uniform resource locator.

### TECHNICAL FIELD OF THE INVENTION

This invention relates in general to communications and, more particularly, to a system and a method for executing a multi-modal transfer in a session initiation protocol (SIP) environment.

### BACKGROUND OF THE INVENTION

The field of communications has become increasingly important in today's society. In particular, the ability to quickly and accurately communicate data presents a significant obstacle for component manufacturers, system designers, and network operators. This obstacle is made even more difficult due to the plethora of diverse technologies that exist in the current marketplace.

As new communication platforms (such as session initiation protocol (SIP), for example) become available to the consumer, new protocols need to be developed in order to appropriately interface with these emerging technologies. For example, certain devices may be ill-equipped to interface with network components such that collected information cannot be suitable relayed from the Internet to a given endpoint. In other scenarios, data transmission and data propagation present a complicated and an arduous task for the end user to complete. Without effective interfacing capabilities, these new platforms are stymied in their operations and inhibited in their performance, as they are unable to take full advantage of the benefits of complimentary network components.

### SUMMARY OF THE INVENTION

From the foregoing, it may be appreciated by those skilled in the art that a need has arisen for an improved data communication process that accommodates multi-modal transmissions. In accordance with an embodiment of the present invention, a system and a method for transmitting and receiving multi-modal data are provided that substantially eliminate or greatly reduce disadvantages and problems associated with conventional data exchange strategies.

According to an embodiment of the present invention, a method for communicating data in a session initiation protocol (SIP) environment is provided that includes initiating a SIP communication session that involves a first endpoint and a second endpoint. The method also includes identifying a portion of data that resides in a network and communicating the data to the second endpoint. In more particular embodiments, the method may further include identifying a uniform resource locator that includes the data and directing the second endpoint to the uniform resource locator.

Certain embodiments of the present invention may provide a number of technical advantages. For example, according to one embodiment of the present invention, an architecture and a process are provided that can be used to deliver accurate data, which originated from a network environment, to a targeted end user (or endpoint). Moreover, such a data propagation protocol may be performed with minimal individual effort from the either the sender or the receiver of the information. This would allow high-quality data to be quickly obtained and clearly displayed in the context of any SIP session.

Moreover, such an architecture can readily be extended to conference call scenarios involving multiple participants. The present invention provides exceptional flexibility in its applications, as any suitable data or information may be properly exchanged between two or more endpoints. Hence, the multi-modal capabilities of the present invention may readily accommodate video, voice, HTML, audio, streaming, real-time (or any combination of these) or any other suitable data type. This, in turn, allows the present invention to be used in a host of environments, such as: in healthcare offices for record keeping purposes, in billing scenarios where a conversation exists between a consumer and a service provider, in offering directions from one location to another, and in virtually any other environment where it may be beneficial to provide some information that would supplement the SIP session that is occurring.

Certain embodiments of the present invention may enjoy some, all, or none of these advantages. Other technical advantages may be readily apparent to one skilled in the art from the following figures, description, and claims.

### BRIEF DESCRIPTION OF THE DRAWINGS

To provide a more complete understanding of the present invention and features and advantages thereof, reference is made to the following description, taken in conjunction with the accompanying figures, wherein like reference numerals represent like parts, in which:

FIG. 1 is a simplified block diagram illustrating a communication system in accordance with one embodiment of the present invention;

FIG. 2 is a simplified flowchart illustrating a number of example steps associated with a method of the communication system of FIG. 1; and

FIG. 3 is a schematic diagram of an example operation of the communication system.

### DETAILED DESCRIPTION OF EXAMPLE EMBODIMENTS

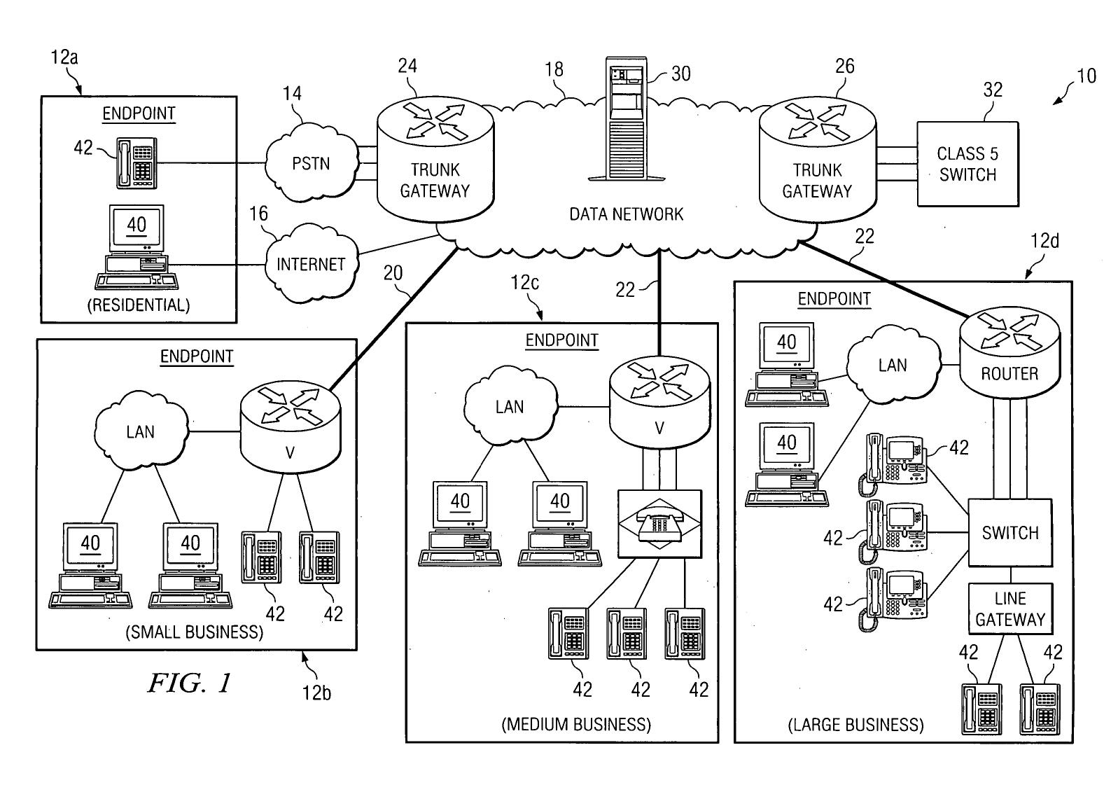

FIG. 1 is a simplified block diagram of a communication system 10 for communicating, receiving, and transmitting data in a session initiation protocol (SIP) environment. Communication system 10 includes endpoints 12a-12d, a public switched telephone network (PSTN) 14, an Internet 16, a data network 18, a broadband access link 20, and a number of additional links 22 (which may include, for example, a digital subscriber line (DSL) link, a T1 link, a fiber optic link, and a wireless link). Communication system 10 also includes a set of trunk gateways 24 and 26, a 3rd-party application server 30, and a Class-5 switch 32.

Endpoint 12a represents a residential location, which consists of a computer 40 and several telephones 42. Telephones 42 may be an Internet protocol (IP) telephone or a standard telephone that is operable to interface with computer 40 such that one or more capabilities of SIP are enabled through telephone 42. Accordingly, two types of telephones are illustrated in FIG. 1. Endpoint 12b represents a small business entity, which consists of a local area network (LAN), a router, several computers 40, and several telephones 42. Endpoint 12c represents a medium business entity, which consists of a LAN, router, a private branch exchange (PBX) or key system, several computers 40, and several telephones 42. Endpoint 12d is a large business entity, which consists of a LAN, a router, a switch, a line gateway, several computers 40, and several telephones 42.

In accordance with the teachings of the present invention, commutation system 10 offers a new voice technology service that allows for the transfer of a voice call in order to accommodate a different communication mode. This allows the transferor (e.g., an attendant, an agent, a co-worker, etc.) to transfer a caller to a web site (or to network data) during the course of the call. For example, the transferor may have input data to provide specific information to the caller (e.g., directions to a location of interest). The voice technology service of the present invention takes advantage of a traditional call transfer service and, further, extends this service to take advantage of other modes of communication to which the caller has access.

In some call transfer paradigms, the call transfer occurs between voice call legs. Leveraging SIP technology, it is possible to transfer a call from one mode of communication (such as voice) to another mode of communication (e.g., web server, instant messaging service, etc.) such that the caller is seamlessly integrated into this new communication mode with the device to which it is transferred. The call transfer is extended beyond voice-to-voice scenarios, allowing it to accommodate voice-to-web supported services. This valuable tool may be utilized and executed with minimal effort from either endpoint involved in the session. In addition, the data (reflecting a different mode or format) may be pushed to a given endpoint while the existing voice session continues. Hence, the original SIP session is not inhibited or encumbered by this multi-mode feature. Virtually, any network data may be retrieved and pushed to a given endpoint.

Endpoints 12a-d are SIP-compatible elements that include hardware and/or software that is operable to receive and to transmit data (directly or indirectly). Note that the term “endpoint” encompasses a myriad of potential devices and infrastructure that may benefit from the operations of communication system 10. Endpoints 12a-d may be a personal digital assistant (PDA), a cellular telephone, a standard telephone (which may be coupled to a personal computer) an IP telephone, a personal computer, a laptop computer, a mobile telephone, or any other suitable device or element (or any appropriate combination of these elements (any of which may be inclusive of a browser)) that is operable to receive data or information. Each endpoint may also include suitable network equipment and appropriate infrastructure (e.g., switches, routers, LANs, gateways, etc.) to facilitate a SIP session. FIG. 1 illustrates only one set of example devices that may be used within communication system 10. The present invention is replete with numerous alternatives that could be used to facilitate the operations of communication system 10.

It should also be noted that the internal structure of endpoints 12a-d are malleable and can be readily changed, modified, rearranged, or reconfigured in order to achieve their intended operations. As identified supra, software and/or hardware may reside in endpoints 12a-d in order to achieve the teachings of the data exchange feature of the present invention. However, due to their flexibility, these elements may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of endpoints 12a-d in the context of communication system 10 and, accordingly, it should be construed as such.

For purposes of teaching and discussion, it is useful to provide some overview as to the way in which the following invention operates in a SIP environment. The following foundational information may be viewed as a basis from which the present invention may be properly explained. Such information is offered earnestly for purposes of explanation only and, accordingly, should not be construed in any way to limit the broad scope of the present invention and its potential applications.

There are many applications of the Internet that require the creation and management of a session, where a session is considered an exchange of data between an association of participants. The implementation of these applications is complicated by the practices of participants: users may move between endpoints, they may be addressable by multiple names, and they may communicate in several different media: in many cases simultaneously. Certain protocols have been developed to carry various forms of real-time multimedia session data such as voice, video, or text messages.

The SIP features of communication system 10 work in concert with these protocols by enabling endpoints (generally referred to as “user agents”) to discover one another and to agree on a characterization of a session they would like to share. For locating prospective session participants, and for other functions, SIP enables the creation of an infrastructure of network hosts (generally referred to as proxy servers) to which user agents can send registrations, invitations to sessions, and other requests. SIP is an agile, general-purpose tool for creating, modifying, and terminating sessions. SIP works independently of underlying transport protocols and without dependency on the type of session that is being established.

SIP is an application-layer control protocol that can establish, modify, and terminate multimedia sessions (conferences) such as Internet telephony calls. SIP can also invite participants to already existing sessions, such as multicast conferences. Media can be added to (and removed from) an existing session. SIP transparently supports name mapping and redirection services, which supports personal mobility. End users can maintain a single externally visible identifier regardless of their network location.

SIP supports five facets of establishing and terminating multimedia communications: 1) user location: determination of the end system to be used for communication; 2) user availability: determination of the willingness of the called party to engage in communications; 3) user capabilities: determination of the media and media parameters to be used; 4) session setup: “ringing” establishment of session parameters at both called and calling party locations; and 5) session management: including transfer and termination of sessions, modifying session parameters, and invoking services.

A standard SIP platform does not provide services. Rather, SIP provides primitives that can be used to implement different services. For example, SIP can locate a user and deliver an opaque object to his current location. If this primitive is used to deliver a session description written in SDP, for instance, the endpoints can agree on the parameters of a session. If the same primitive is used to deliver a photo of the caller as well as the session description, a “caller ID” service can be easily implemented.

SIP currently does not offer conference control services such as floor control or voting and does not prescribe how a conference is to be managed. SIP can be used to initiate a session that uses some other conference control protocol. Since SIP messages and the sessions they establish can pass through entirely different networks, SIP cannot, and does not, provide any kind of network resource reservation capabilities. Quality of service (QoS) parameters may also be accommodated by SIP (e.g., see RFC 3311).

The nature of the services provided make security particularly important. To that end, SIP provides a suite of security services, which include denial-of-service prevention, authentication (both user to user and proxy to user), integrity protection, and encryption and privacy services.

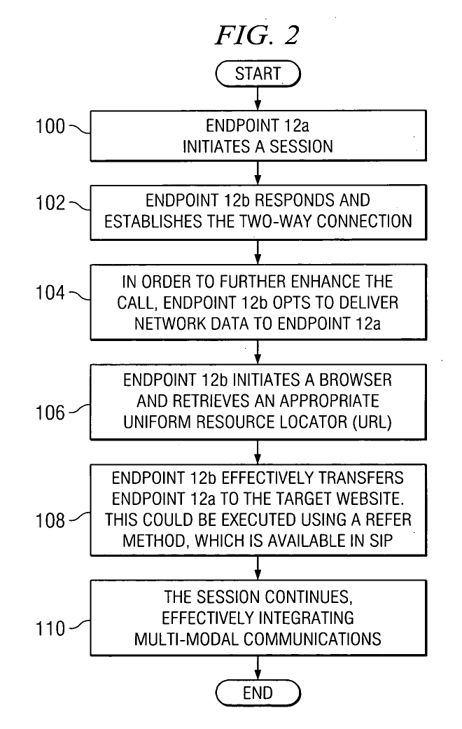

FIG. 2 is a simplified flowchart illustrating a number of example steps associated with a method to be performed within communication system 10. The flowchart begins at step 100, where endpoint 12a initiates a SIP session. This could include simple invite messages or any other suitable protocol to establish the session. At step 102, endpoint 12b responds affirmatively and, thereby, establishes the two-way connection. In order to further enhance the call, endpoint 12b opts to deliver network data to endpoint 12a at step 104. In order to achieve this data transfer, endpoint 12b initiates a browser and retrieves an appropriate uniform resource locator (URL) at step 106. Endpoint 12b effectively delivers the data to endpoint 12a or, alternatively, transfers endpoint 12a to the target website at step 108. This could be executed using a refer method, which is available in the SIP platform. The underlying voice session may continue uninterrupted, whereby the session has, effectively integrated multi-modal communications, as is reflected by step 110. Endpoints may be continuously replaced or added during the SIP communication session. Additional details relating to these operations are provided below in the context of numerous examples used for purposes of teaching and discussion.

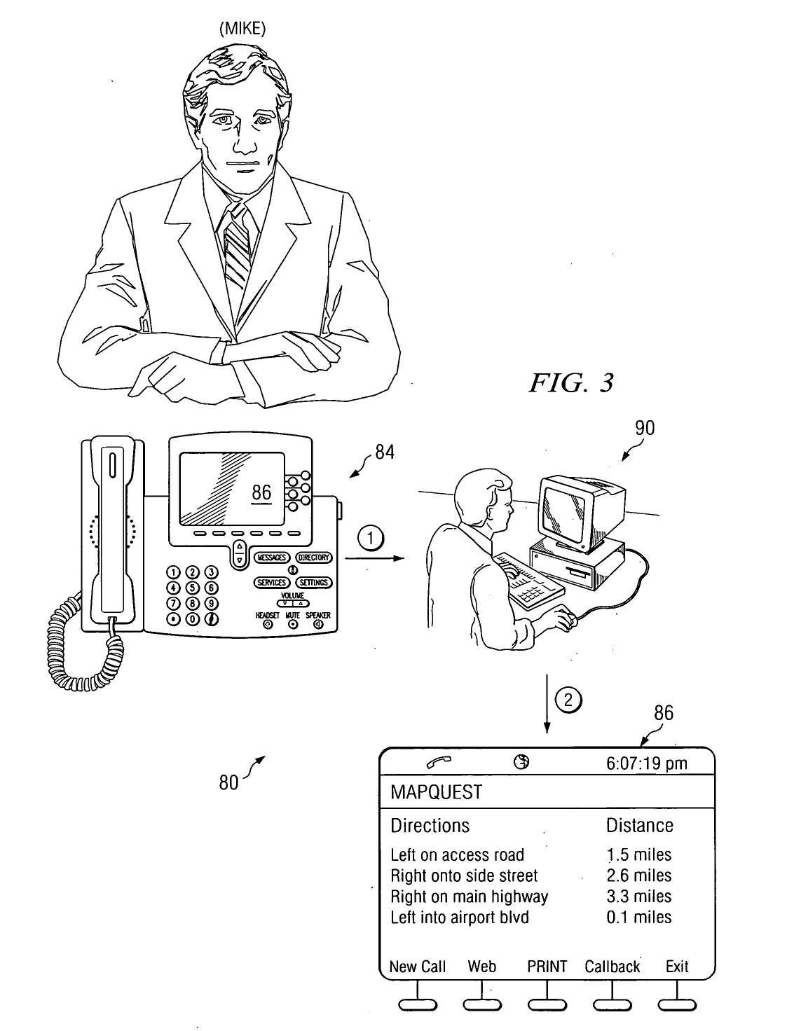

FIG. 3 is a simplified schematic diagram of another example operational flow that may be executed in communication system 10. In the example of FIG. 3, the end user Mike, who resides in Boulder, Colo. and who is currently doing business in San Jose, Calif. is in need of directions to the local airport. Mike is able to use an IP telephone 84, which includes a display 86. IP telephone 84 may include any number of features that further enhance the end user's experience (e.g. print capabilities, caller ID, call back features, etc.) IP telephone 84 is enabled for services that allow data to be pushed to display 86 and, thereby, to Mike.

In this example, Mike initiates a call to a lobby ambassador 90 at step one. Lobby ambassador 90 is SIP-enabled in that it is capable of recognizing messages endemic to the SIP platform. At this point in the process, display 86 may depict standard call information such as: who Mike is calling, the number dialed, a photograph of any of the participants, one or more time parameters, etc. Lobby ambassador 90 may be using a similar IP telephone or be equipped with a simple computer, as is illustrated in FIG. 3. As the discussion progresses, lobby ambassador 90 has one of several options: 1) direct Mike verbally; 2) offer Mike a pre-printed sheet of directions; 3) verbally offer Mike the number of the airport for which directions are sought; or 4) transfer Mike to a different media such that multi-modal connections are facilitated. In this example, lobby ambassador 90 elects option 4.

At step 2, lobby ambassador 90 initiates a browser (which may be included in any endpoint) and retrieves an appropriate uniform resource locator (URL) (such as Map Quest, for example) that offers the requested directions. The refer method in this example could have Mike's endpoint set up with a unique SIP session that links to Map Quest. This could include a unique identifier or a web-link to a page lobby ambassador 90 has previously established after progressing through the Map Quest site. Lobby ambassador 90 may simply transfer or link Mike to that website. This could be executed using a refer method, which is available in SIP. The refer method could also indicate to Mike to send an invite message, or the refer method could send an invite with the SIP session, or the refer method could directly position the URL using Mike's browser such that a link to Map Quest is provided. In effect, all of these approaches are integrating voice and web technology in order to offer enhanced services to Mike.

Note that the retrieval of directions is only one of a number of possible application for the execution of multi-modal communications in the present invention. Other data applications could involve medical applications, whereby records can readily be displayed to an end user quickly and accurately. Other applications could involve quarterly financial conference calls, whereby a participant in the conference call can easily bring up specific portions of the 10K, 10Q, etc. Hence, a participant could highlight relevant portions of the quarterly or annual report for discussion purposes. This would achieve a multi-modal conference call, whereby any number of participants may readily be accommodated by the call.

Still other applications could involve disputes concerning normal billing cycles. For example, in the context of a billing question between a customer and a service provider, the representative of the service provider could bring up a previous bill or the contract terms on which the customer and the service provider agreed. Yet other applications could include work environment scenarios where colleagues can effectively interact with each other. Other applications could include non-business calls where two people simply desire to share some type of multi-media data. Note that any such arrangements and configurations, and applications are clearly within the broad scope of the present invention. Communication system 10 is replete with such alternatives and permutations and, accordingly, should be construed as such.

It should be noted that the internal structure of the system of FIG. 3 is malleable and can be readily changed, modified, rearranged, or reconfigured in order to achieve its intended operations or additional operations. Additionally, any of the items within FIG. 3 may be combined, where appropriate, or replaced with other functional elements that are operable to achieve any of the operations described herein.

It is also important to note that the stages and steps in FIGS. 2 and 3 illustrate only some of the possible scenarios that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within communication system 10 to effectuate the tasks and operations of the elements and activities associated with executing multi-modal communications.

Although the present invention has been described in detail with reference to particular embodiments, it should be understood that various other changes, substitutions, and alterations may be made hereto without departing from the spirit and scope of the present invention. For example, the illustrated network architecture of FIG. 1 has only been offered for purposes of example and teaching. Suitable alternatives and substitutions are envisioned and contemplated by the present invention: such alternatives and substitutions being clearly within the broad scope of communication system 10. For example, the use of the LAN could easily be replaced by a virtual private network (VPN), a metropolitan area network (MAN), a wide area network (WAN), a wireless LAN (WLAN), or any other element that facilitates data propagation for endpoints 12a-d. Using analogous reasoning, the routers and switches illustrated by FIG. 1 may be supplanted by bridges, gateways, or any other suitable devices that are conducive to network communications. Note also that the data to be delivered to an endpoint may reside in a VPN, or the Internet, an Intranet, or any other appropriate network location.

It should also be noted that in contrast to other technologies, SIP establishes a session, not a voice path. When the session is negotiated, the type of session to be facilitated is identified. For example, the session type could be a web session, an IP video session, a voice session, etc. Hence, provided that the two endpoints understand the session to be executed, the session may be transferred to any suitable format or media. Hence, virtually any two endpoints may be used to effectuate these operations and others as detailed herein. What is of critical importance is the interoperability of the two endpoints. If both endpoints understand the mode or the media (e.g. video, XML, HTML, audio, streaming) then any suitable transfer can be effectuated.

Numerous other changes, substitutions, variations, alterations, and modifications may be ascertained to one skilled in the art and it is intended that the present invention encompass all such changes, substitutions, variations, alterations, and modifications as falling within the spirit and scope of the appended claims.

What is claimed is:

1. A method for communicating data in a session initiation protocol (SIP) environment, comprising:
initiating a SIP communication session that involves a first endpoint and a second endpoint;
identifying a portion of data that resides in a network; and
communicating the data to the second endpoint.

2. The method of claim 1, wherein communicating the data further comprises directing the second endpoint to a network location that includes the data.

3. The method of claim 1, further comprising:
inviting a third endpoint to join the SIP communication session.

4. The method of claim 1, further comprising:
conducting a voice session concurrently with communicating the data to the second endpoint.

5. The method of claim 4, wherein the first endpoint is a selected one of a group of devices, the group consisting of:
a) a personal computer;
b) a laptop;
c) a personal digital assistant;
d) an Internet protocol (IP) telephone;
e) a standard telephone; and
f) a mobile telephone.

6. The method of claim 1, wherein the data is included at a web site.

7. The method of claim 1, wherein identifying the data further comprises identifying a uniform resource locator.

8. The method of claim 1, wherein the data is provided in a selected one of a group of formats, the group consisting of:
a) a video format;
b) an audio format;
c) an XML format;
d) a real-time multimedia format;
e) a voice format;
f) a streaming format; and
g) an HTML format.

9. An apparatus for communicating data in a session initiation protocol (SIP) environment, comprising:
a first endpoint operable to initiate a SIP communication session that involves the first endpoint and a second endpoint, wherein a portion of data that resides in a network may be identified, the first endpoint being operable to communicate the data to the second endpoint.

10. The apparatus of claim 9, wherein the first endpoint is further operable to direct the second endpoint to a network location that includes the data.

11. The apparatus of claim 9, further comprising:
a third endpoint, wherein the first endpoint is further operable to invite the third endpoint to join the SIP communication session or to replace the second endpoint in the SIP communication session.

12. The apparatus of claim 9, wherein a voice session is conducted between the first endpoint and the second endpoint concurrently with communicating the data to the second endpoint.

13. The apparatus of claim 9, wherein the first endpoint is a selected one of a group of devices, the group consisting of:
a) a personal computer;
b) a laptop;
c) a personal digital assistant;
d) an Internet protocol (IP) telephone;
e) a standard telephone; and
f) a mobile telephone.

14. The apparatus of claim 9, further comprising:
a browser included in the first endpoint, wherein the browser is operable to identify a uniform resource locator that includes the data, and wherein the uniform resource locator is sent to the second endpoint.

15. The apparatus of claim 9, wherein the data is provided in a selected one of a group of formats, the group consisting of:
a) a video format;
b) an audio format;
c) an XML format;
d) a real-time multimedia format;
e) a voice format; and
f) a streaming format.

16. Software for communicating data in a session initiation protocol (SIP) environment, the software being embodied in a computer readable medium and comprising computer code such that when executed is operable to:
initiate a SIP communication session that involves a first endpoint and a second endpoint;
identify a portion of data that resides in a network; and
communicate the data to the second endpoint.

17. The medium of claim 16, wherein the code is further operable to:
direct the second endpoint to a network location that includes the data.

18. The medium of claim 16, wherein the code is further operable to:
invite a third endpoint to join the SIP communication session or to replace the second endpoint in the SIP communication session.

19. The medium of claim 16, wherein the code is further operable to:
conduct a voice session concurrently with communicating the data to the second endpoint.

20. The medium of claim 16, wherein the code is further operable to:
identify a uniform resource locator to be delivered to the second endpoint.
